(19) United States
(12) Patent Application Publication
(10) Pub. No.: US 2018/0253197 A1
(43) Pub. Date: Sep. 6, 2018

(54) INFORMATION PROCESSING APPARATUS AND NON-TRANSITORY COMPUTER READABLE MEDIUM STORING PROGRAM

(71) Applicant: FUJI XEROX CO.,LTD., TOKYO (JP)

(72) Inventors: Jun OHASHI, Kanagawa (JP); Yoshihito SUEZAWA, Kanagawa (JP); Shinsuke NAKAZAWA, Kanagawa (JP); Taro YOSHIHAMA, Kanagawa (JP); Toshiyuki KOMODA, Kanagawa (JP); Masahiro YAMADA, Kanagawa (JP)

(73) Assignee: FUJI XEROX CO.,LTD., TOKYO (JP)

(21) Appl. No.: 15/796,865

(22) Filed: Oct. 30, 2017

(30) Foreign Application Priority Data
Mar. 2, 2017 (JP) 2017-039188

(51) Int. Cl. G06F 3/0482; G06F 3/0485

(52) U.S. Cl. CPC G06F 3/0482; G06F 9/44; H04N 2201/0094; G06F 3/04855

(57) ABSTRACT

An information processing apparatus includes a memory that, in a case where a reception unit receives an instruction among plural reception units which respectively receive instructions relevant to generation or editing of a product in a recording mode, stores the product and the reception unit in association with each other; and a display controller that, in a case where the product is selected in a learning mode, performs control such that the reception unit, which is stored in the memory in association with the selected product, is displayed in a predetermined area.

### CROSS-REFERENCE TO RELATED APPLICATIONS

This application is based on and claims priority under 35 USC 119 from Japanese Patent Application No. 2017-039188 filed Mar. 2, 2017.

### BACKGROUND

### Technical Field

The present invention relates to an information processing apparatus and a non-transitory computer readable medium storing a program.

### SUMMARY

According to an aspect of the invention, there is provided an information processing apparatus including: a memory that, in a case where a reception unit receives an instruction among plural reception units which respectively receive instructions relevant to generation or editing of a product in a recording mode, stores the product and the reception unit in association with each other; and a display controller that, in a case where the product is selected in a learning mode, performs control such that the reception unit, which is stored in the memory in association with the selected product, is displayed in a predetermined area.

### BRIEF DESCRIPTION OF THE DRAWINGS

Exemplary embodiment(s) of the present invention will be described in detail based on the following figures, wherein:

FIG. 1 is a block diagram illustrating an example of a configuration of an information processing system according to an exemplary embodiment of the invention;

FIG. 2 is a diagram illustrating an example of an operation log table;

FIG. 3 is a diagram illustrating an example of a dedicated tool bar table;

FIG. 4 is a flowchart illustrating an example of an operation of an information processing apparatus in a recording mode;

FIG. 5 is a diagram illustrating an example of a work screen;

FIG. 6 is a diagram illustrating an example of the work screen;

FIG. 7 is a diagram illustrating an example of the work screen;

FIG. 8 is a diagram illustrating an example of the work screen;

FIG. 9 is a flowchart illustrating an example of an operation of the information processing apparatus in a learning mode;

FIG. 10 is a diagram illustrating an example of the work screen; and

FIG. 11 is a flowchart illustrating an example of the operation of the information processing apparatus in the learning mode.

### DETAILED DESCRIPTION

Hereinafter, an exemplary embodiment of the invention will be described with reference to the accompanying drawings. Meanwhile, the same reference numeral is attached to a component which has substantially the same function in each drawing and the description thereof will not be repeated.

### Overview of Exemplary Embodiment

An information processing apparatus according to the exemplary embodiment includes: a memory that, in a case where a reception unit receives an instruction among plural reception units which respectively receive instructions relevant to generation or editing of a product in a recording mode, stores the product and the reception unit in association with each other; and a display controller that, in a case where the product is selected in a learning mode, performs control such that the reception unit, which is stored in the memory in association with the selected product, is displayed in a predetermined area.

A “product” includes, for example, a document, an image, and the like. The document may include data of a photograph, a chart, an illustration, and the like. “Editing” includes not only editing of a document or an image itself but also a process of integrating plural documents and images into one.

A “reception unit” is provided to execute a function which is used in a case of generating or editing the product. The “reception unit” may be a button, may be an icon which is expressed by a picture or picture writing. The reception unit may be expressed by letters or by figures and letters.

### Exemplary Embodiment

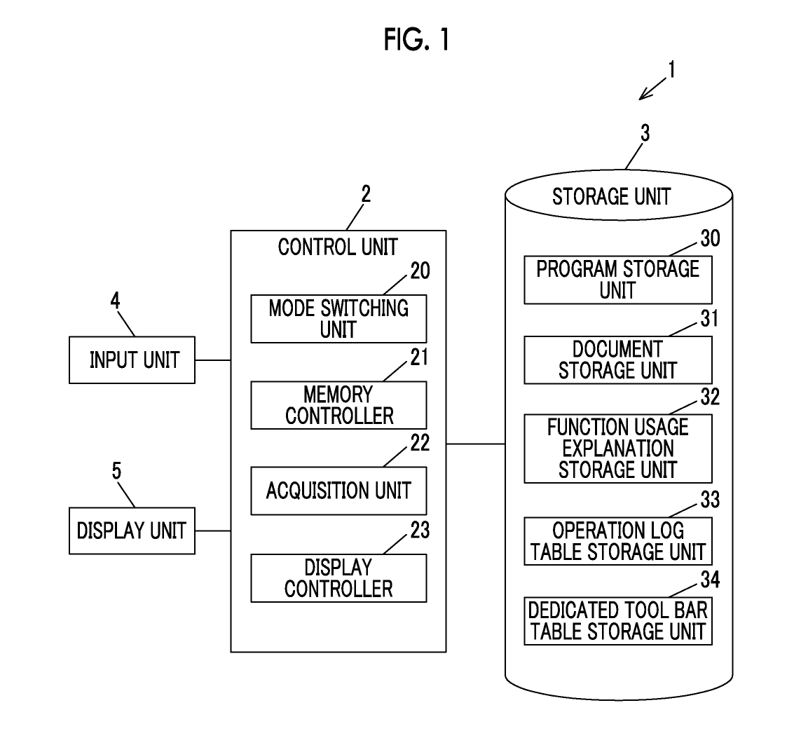

FIG. 1 is a block diagram illustrating an example of a configuration of an information processing system according to an exemplary embodiment of the invention.

An information processing apparatus 1 includes a control unit 2 that controls respective units of the apparatus 1, a storage unit 3 that stores various pieces of information, an input unit 4 that is realized by a keyboard, a mouse, and the like, and a display unit 5 that is realized by a liquid crystal display. The storage unit 3 is an example of the memory.

Meanwhile, the input unit 4 and the display unit 5 may include a touch panel display. It is possible to use, for example, a mobile information processing apparatus, such as a personal computer or a multi-function mobile phone (smart phone), as the information processing apparatus 1.

The control unit 2 includes a Central Processing Unit (CPU), an interface, and the like. The CPU functions as a mode switching unit 20, a memory controller 21, an acquisition unit 22, a display controller 23, and the like in such a way as to operate according to a program that is stored in a program storage unit 30 of the storage unit 3. The respective units and controllers 20 to 23 will be described in detail later.

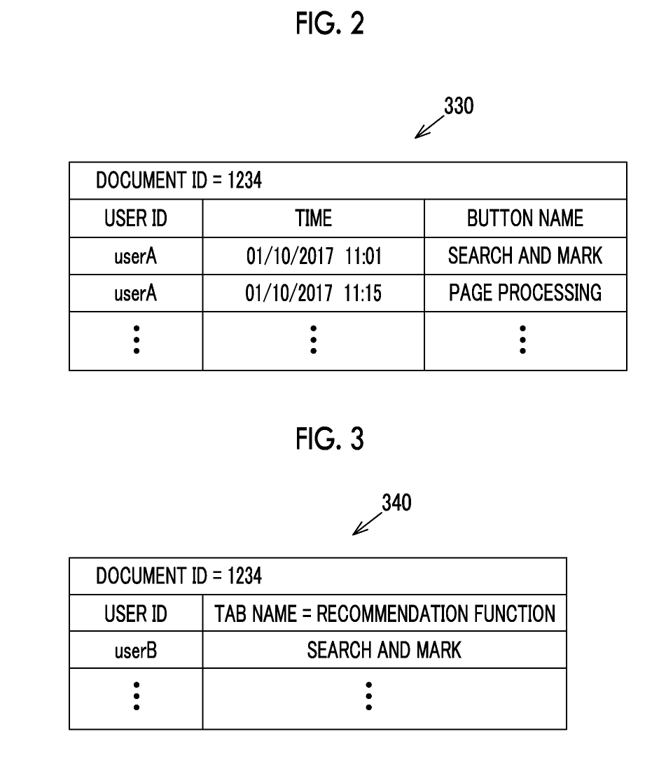

The storage unit 3 includes a Read Only Memory (ROM), a Random Access Memory (RAM), a hard disk, and the like. The storage unit 3 includes a program storage unit 30 that stores a program, such as document handling software which manages a document, a document storage unit 31 that stores a document, a function usage explanation storage unit 32 that stores usage explanation (also referred to as a manual) of a function, an operation log table storage unit 33 that stores an operation log table 330 (see FIG. 2), and a dedicated tool bar table storage unit 34 that stores a dedicated tool bar table 340 (see FIG. 3). The document is an example of the product.

The document handling software may be capable of managing, for example, a paper document which is read by a scanner through digitizing, may be also capable of managing document data which are prepared by different applications by integrating the document data into one document, and may be capable of performing editing operations such as drawing a marker in an electronic document, making a comment, putting a tag, and affixing a stamp.

The document storage unit 31 stores plural documents, images, and the like which are associated with document IDs that identify the documents.

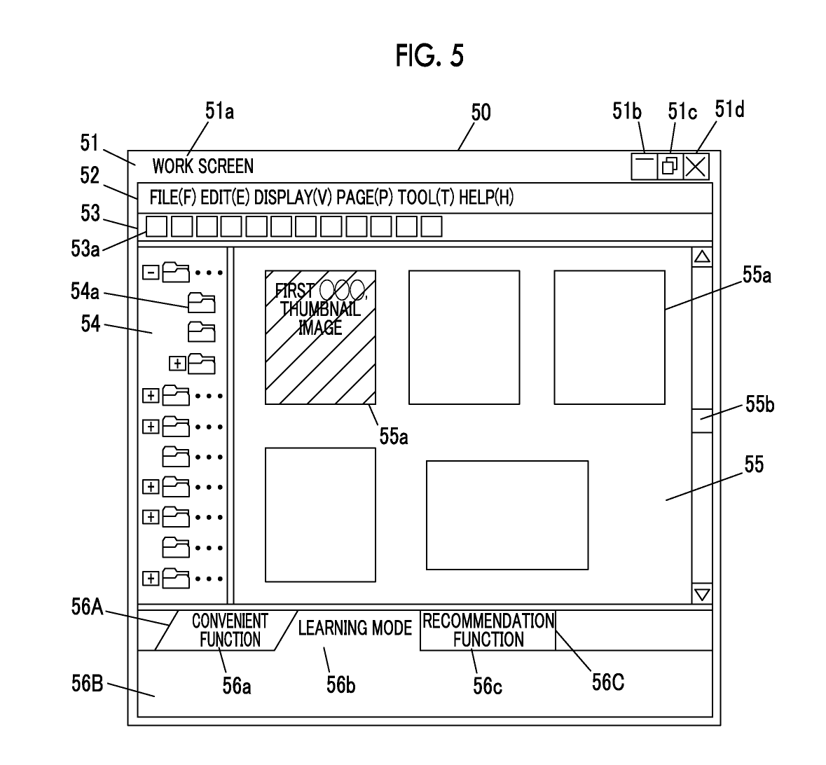

The function usage explanation storage unit 32 stores usage explanation of functions of buttons 53a, which are disposed in a standard tool bar 53 (see FIG. 5), in association with the buttons 53a.

FIG. 2 is a diagram illustrating an example of the operation log table 330. The operation log table 330 is provided for every document ID which identifies a document. FIG. 2 illustrates a case where the document ID is “1234”. In the operation log table 330, a button name of a button which has been used by a user is recorded as an operation log. The operation log table 330 is provided with a “user ID” field in which a user ID that identifies the user is recorded, an “hour” field in which an hour (year/month/date/time) at which the button is operated is recorded, and a “button name” field in which the button name of the used button is recorded. FIG. 2 illustrates a case in which “search and mark” and “page processing” are recorded in the “button name” field. The button is an example of the reception unit.

The “search and mark” indicates that, for example, in a case where a search target document is selected and strings desired to be found is input by clicking a “search and mark” button, a marker is drawn on the strings which are found as a search result and a tag is put on a relevant page. The “page processing” indicates that, for example, processes of changing a data format, changing a resolution, and the like are performed.

FIG. 3 is a diagram illustrating an example of the dedicated tool bar table 340. The dedicated tool bar table 340 is provided for every document ID. FIG. 3 illustrates the case where the document ID is “1234”. The dedicated tool bar table 340 is provided with a “user ID” field in which the user ID is recorded, and a “tab name” field of a “recommendation function”, in which a button name of a recommended button is recorded. In the “tab name” field of the “recommendation function”, a button name of a button, which is operated to read usage explanation of a function, is recorded among buttons displayed on a learning mode-dedicated tool bar 56B (see FIG. 5).

### Configuration of Work Screen

A configuration of a work screen displayed on the display unit 5 will be described with reference to FIG. 5. FIG. 5 is a diagram illustrating an example of the work screen in the learning mode. A work screen 50 is provided with a title bar 51, a menu bar 52, a standard tool bar 53, a folder section 54, a work space section 55, three dedicated tool bars 56A, 56B, and 56C, and the like.

The title bar 51 is provided with a title 51a, a minimization button 51b, a maximization button 51c, and a close button 51d. On the standard tool bar 53, the plural buttons 53a, which are prepared as a standard tool by the document handling software, are disposed.

The folder section 54 is an area which displays a tree configuration of folders 54a. The work space section 55 is an area in which documents 55a in a folder 54a selected in the folder section 54 are displayed as thumbnail images. The work space section 55 is an area which is used to generate and edit the documents. The work space section 55 is provided with a scroll bar 55b which changes a display range of the workspace section 55.

Each of the three dedicated tool bars 56A, 56B, and 56C forms a screen (referred to as a “tab screen”) which includes a tab. That is, there are provided a convenient function-dedicated tool bar 56A which has a “convenient function” tab 56a, the learning mode-dedicated tool bar 56B which has a “learning mode” tab 56b, and a recommendation function-dedicated tool bar 56C which has a “recommendation function” tab 56c. A recommendation function-dedicated tool bar 56C is an example of an area which is different from a predetermined area.

The convenient function-dedicated tool bar 56A is displayed with a button, which is selected because of being frequently used by the user, among the buttons 53a disposed on the standard tool bar 53. The learning mode-dedicated tool bar 56B is displayed with a button which is used in the learning mode. The recommendation function-dedicated tool bar 56C is displayed with a button which is recommended. The learning mode-dedicated tool bar 56B is an example of the predetermined area. In addition to a method of displaying the button which is recommended in the recommendation function-dedicated tool bar 56C, there may be provided a method of highlighting a button which is displayed in the learning mode-dedicated tool bar 56B.

In a case where the recording mode is selected through an operation of the input unit 4, the mode switching unit 20 switches a mode into the recording mode. In a case where the “learning mode” tab 56b is clicked in the work screen 50, the mode is switched from the recording mode into the learning mode.

The memory controller 21 performs control such that, in a case where, in the recording mode, a button receives an instruction among the plural buttons which respectively receive instructions relevant to generation or editing of the product, the storage unit 3 stores the product and the button in association with each other. That is, in a case where a button 53a is designated among the plural buttons 53a which are disposed on the standard tool bar 53, the memory controller 21 records a document and the designated button in the operation log table 330. In addition, in a case where the button displayed on the learning mode-dedicated tool bar 56B is selected, the memory controller 21 records a button name of the selected button as the recommendation function in the “tab name” field of the dedicated tool bar table 340.

The acquisition unit 22 acquires an operation log corresponding to the selected document from the operation log table 330.

In a case where the button displayed on the learning mode-dedicated tool bar 56B is selected in the learning mode, the display controller 23 performs control such that usage explanation of a function corresponding to the instruction received by the button is displayed.

In addition, the display controller 23 performs control such that a button, which displays the usage explanation of the function, is displayed as a function of recommendation for the button on the recommendation function-dedicated tool bar 56C. In this case, the button may be displayed on the recommendation function-dedicated tool bar 56C by checking a fact that the button name is recorded in the dedicated tool bar table 340.

In a case where a component of the product is selected among the buttons which are displayed on the learning mode-dedicated tool bar 56B, the display controller 23 performs control such that a button, which has received the instruction in a case where the component is generated or edited, is highlighted.

Meanwhile, in a case where the button, which is displayed as the function of recommendation, is instructed a number of times which is equal to or larger than a threshold, the display controller 23 may perform control such that the display as the function of recommendation stops. In addition, in a case where the button, which is displayed on the learning mode-dedicated tool bar 56B, is designated a number of times which is equal to or larger than the threshold, the display controller 23 may perform control such that the button is excluded from the learning mode-dedicated tool bar 56B. In addition, the display controller 23 may perform control such that the button which is displayed as the function of recommendation is excluded from the learning mode-dedicated tool bar 56B.

### Operation of Exemplary Embodiment

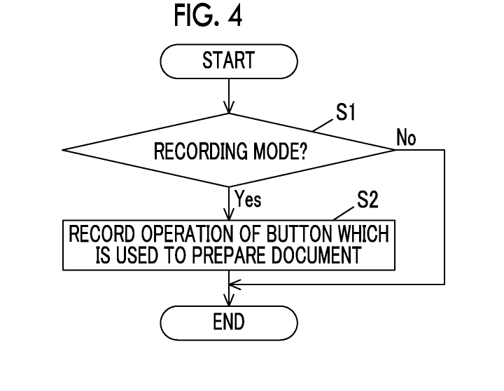

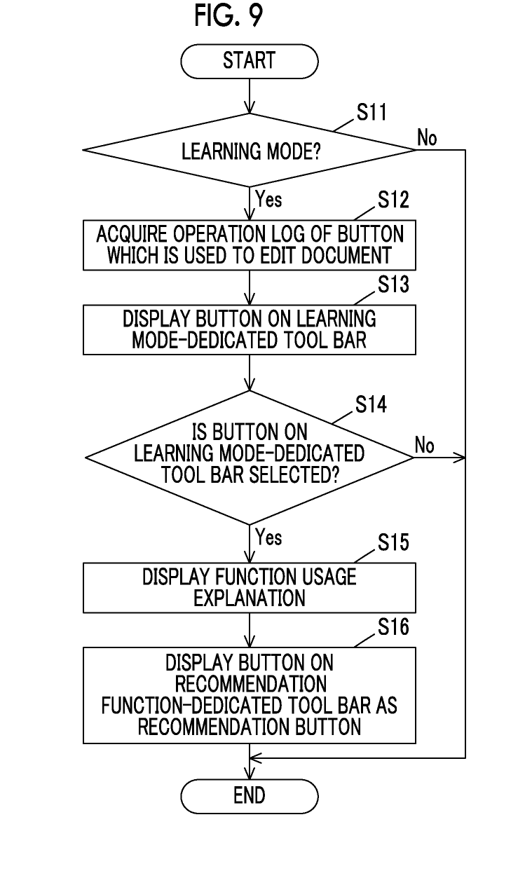

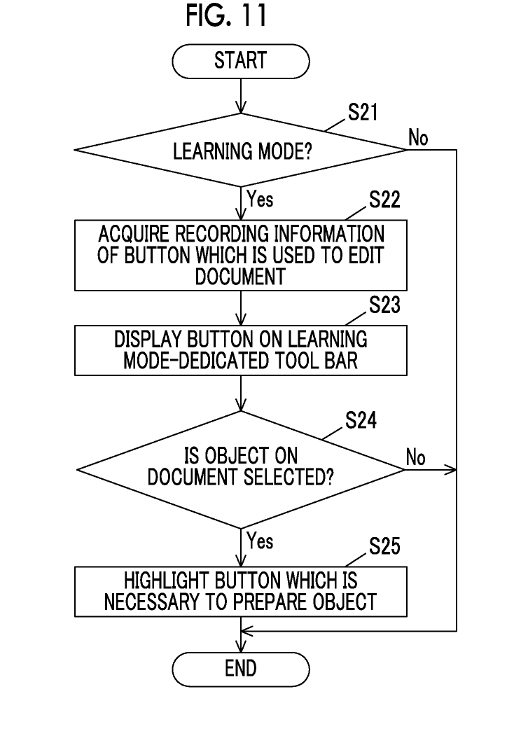

Subsequently, an example of an operation of the information processing apparatus 1 according to the exemplary embodiment will be described with reference to FIGS. 5 to 11. FIG. 4 is a flowchart illustrating the example of the operation of the information processing apparatus 1 in the recording mode. FIGS. 5 to 8 and FIG. 10 are diagrams illustrating examples of the work screen. FIGS. 9 and 11 are flowcharts illustrating examples of an operation of the information processing apparatus 1 in the learning mode.

Hereinafter, a case where a user A who has a “user A” as the user ID edits a document and a user B who has a “user B” as the user ID learns editing of the document the user A.

(1) Recording Mode

The operation in the recording mode will be described according to the flowchart of FIG. 4.

The user A inputs the user ID “user A” of the user A by operating the input unit 4, and selects the recording mode (S1). The mode switching unit 20 sets the mode of the apparatus 1 to the recording mode. The user A starts the document handling software stored in the program storage unit 30 by operating the input unit 4. With the start of the document handling software, the display controller 23 displays the work screen 50 illustrated in FIG. 5 on the display unit 5.

Subsequently, the user A selects an editing target document 55a (for example, a hatched document) from the plural documents 55a which are displayed on the work space section 55.

Subsequently, the user A clicks and selects a button 53a to be used for editing among the buttons 53a which are displayed on the standard tool bar 53, and edits the editing target document. The memory controller 21 records an operation of the selected button 53a in the operation log table 330 (S2).

For example, in a case where a “page processing” button 53a is selected and the editing target is edited after a “search and mark” button 53a is selected and the editing target is edited, the user ID is recorded in the “user ID” field of the operation log table 330, an hour at which the button 53a is operated is recorded in the “time” field, and “search and mark” and “page processing”, which are names of the respective buttons 53a, are recorded in the “button name” field, as illustrated in FIG. 2.

(2) Learning Mode

The operation in the learning mode will be described according to the flowchart of FIG. 9.

The user B clicks and selects the “learning mode” tab 56b of the work screen 50 illustrated in FIG. 5 (S11: Yes). The mode switching unit 20 switches the mode of the apparatus 1 from the recording mode into the learning mode.

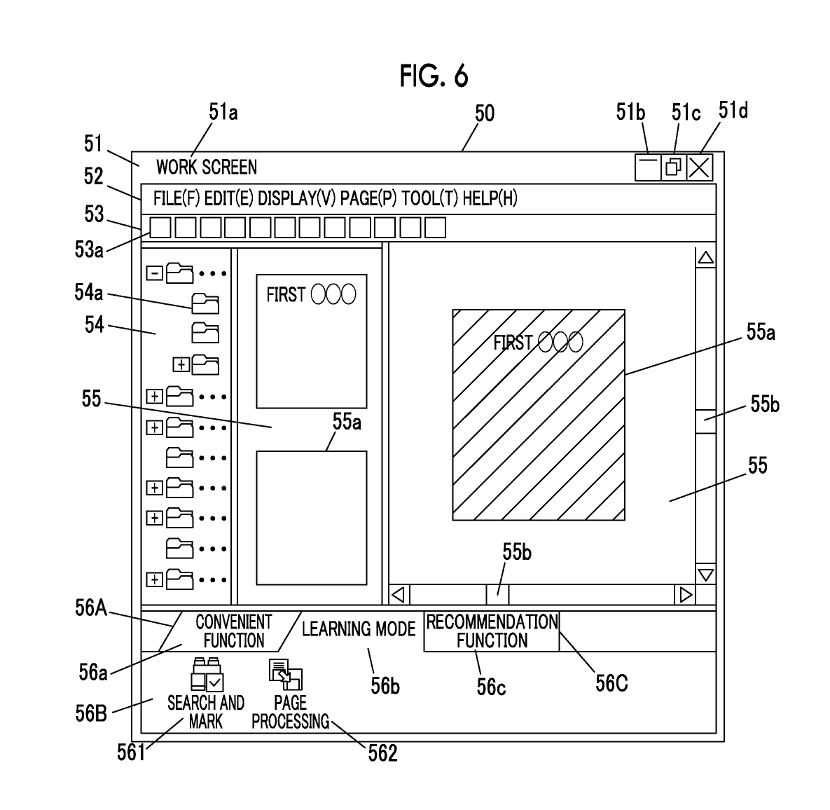

The user B clicks and selects a target document 55a desired to learn. The display controller 23 enlarges and displays the selected document 55a expressed by a thumbnail image in a window 58 which is open on the work space section 55, as illustrated in FIG. 6. The acquisition unit 22 acquires the operation log corresponding to the selected document 55a from the operation log table 330 (S12).

The display controller 23 displays used buttons on the learning mode-dedicated tool bar 56B of the work screen 50 based on the acquired operation log (S13), as illustrated in FIG. 6.

On the learning mode-dedicated tool bar 56B illustrated in FIG. 6, a “search and mark” button 561 and a “page processing” buttons 562 are displayed in time series by the order of use.

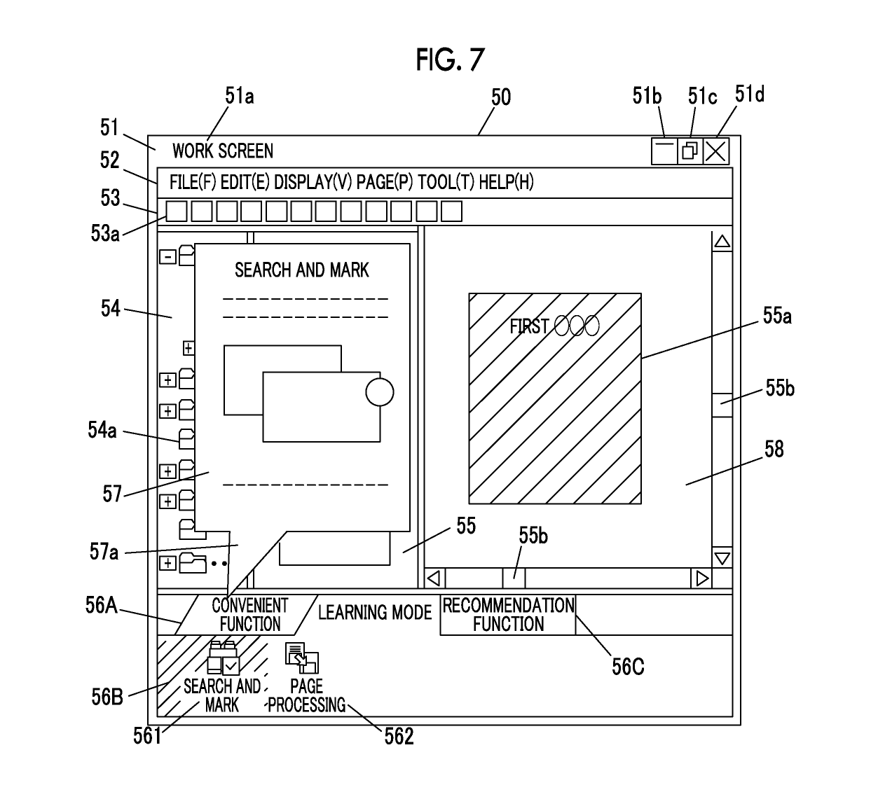

Subsequently, in a case where the user B double-clicks and selects any one button (for example, the button 561) between the buttons 561 and 562 which are displayed on the learning mode-dedicated tool bar 56B (S14: Yes), the display controller 23 reads usage explanation 57 of a function corresponding to the selected button 561 from the function usage explanation storage unit 32, and displays the usage explanation 57 of the function in the work screen 50 (S15), as illustrated in FIG. 7. The usage explanation 57 of the function may be a static image or a moving image. In addition, the usage explanation 57 of the function may be browsed through scrolling.

In the work screen 50 illustrated in FIG. 7, the usage explanation 57 of the function is displayed through popup. In addition, in FIG. 7, the “search and mark” button 561 is highlighted in order to indicate a fact that the “search and mark” button 561 is selected. As the highlighting, for example, a rectangular area (hashed area of FIG. 7), which includes the “search and mark” button 561, may be displayed using a specific color or the “search and mark” button 561 may be displayed using an arrow 57a from the usage explanation 57 of the function, as illustrated in the drawing. In addition, the “search and mark” button 561 or the button name may be displayed such that the “search and mark” button 561 or the button name is larger than another button 562 or another button name, or the “search and mark” button 561 may flicker.

The memory controller 21 records the button name “search and mark” as the recommendation function in the “tab name” field of the dedicated tool bar table 340 illustrated in FIG. 3.

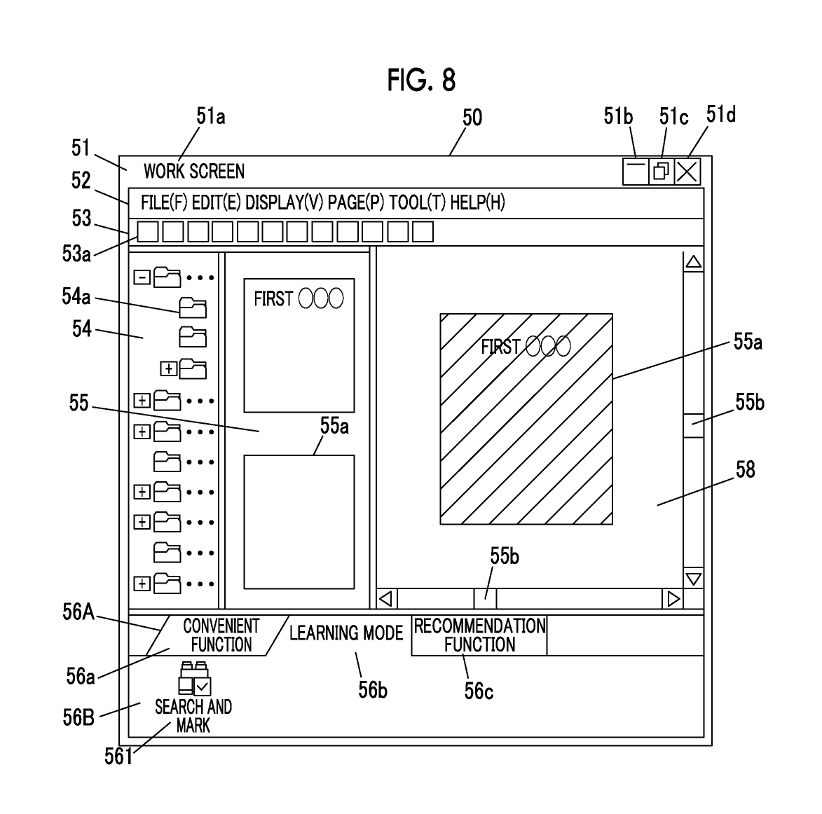

The display controller 23 displays the button 561 on the recommendation function-dedicated tool bar 56C as the recommendation button (S16), as illustrated in FIG. 8.

On the recommendation function-dedicated tool bar 56C illustrated in FIG. 8, the “search and mark” button 561 is displayed.

(3) Another Learning Mode

An operation in another learning mode will be described according to a flowchart of FIG. 11.

The user B clicks and selects the “learning mode” tab 56b of the work screen 50 illustrated in FIG. 5 (S21: Yes). The mode switching unit 20 switches the mode of the apparatus 1 from the recording mode into the learning mode.

The user B clicks and selects the target document 55a desired to learn, which is expressed by the thumbnail image. The display controller 23 enlarges and displays the selected document 55a expressed by the thumbnail image in the window 58 which is open on the work space section 55, as illustrated in FIG. 6. The acquisition unit 22 acquires the operation log corresponding to the selected document 55a from the operation log table 330 (S22).

The display controller 23 displays the used button on the learning mode-dedicated tool bar 56B of the work screen 50 based on the acquired operation log (S23), as illustrated in FIG. 6.

On the learning mode-dedicated tool bar 56B illustrated in FIG. 6, the “search and mark” button 561 and the “page processing” button 562 are displayed.

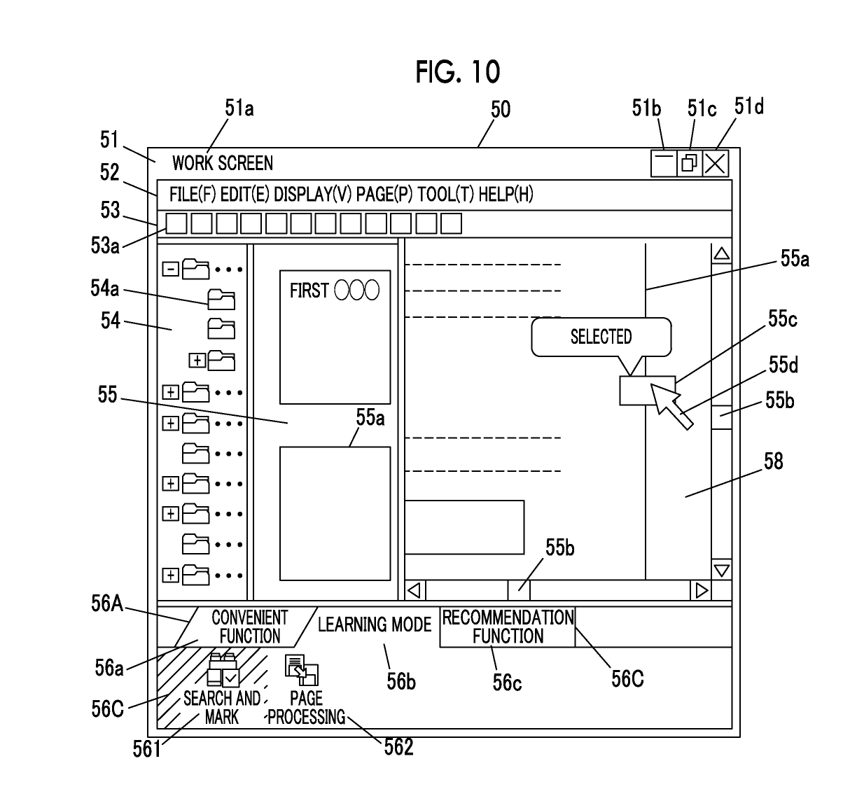

Subsequently, in a case where the user B moves a cursor 55d to an object on the document 55a, for example, a tag 55c in the work screen 50 illustrated in FIG. 6 and selects the tag 55c (see FIG. 10), the display controller 23 determines that the tag 55c of the object is selected (S24: Yes), and highlights the “search and mark” button 561 corresponding to the selected object between the buttons 561 and 562 which are displayed on the learning mode-dedicated tool bar 56B, as illustrated in FIG. 10. Thus, it is possible to intuitively know the button which is used to prepare the object (including both manual and automatic cases). The highlighting may be performed, for example, in such a way that the rectangular area including the “search and mark” button 561 is displayed using a specific color as illustrated in the drawing, or may be performed according to another aspect. The object is an example of the component of the product.

### MODIFIED EXAMPLE

Hereinabove, although the exemplary embodiment of the invention has been described, the exemplary embodiment of the invention is not limited to the above-described exemplary embodiment and various changes and executions are possible without departing from the gist of the invention. Although the case where the document is edited is described in the above exemplary embodiment, it is possible to apply the invention to a case where the document is prepared.

Apart or all of the respective units of the control unit may be formed by a hardware circuit such as a Field Programmable Gate Array (FPGA) or specific Application Specific Integrated Circuit (ASIC).

In addition, it is possible to omit and change a part of the components of the above-described exemplary embodiment without departing from the gist of the invention. In addition, it is possible to add, remove, change, and replace steps in the flow of the above-described exemplary embodiment without departing from the gist of the invention. In addition, it is possible to provide the program, which is used in the exemplary embodiment, by recording the program in a computer-readable recording medium such as a CD-ROM. In addition, it is possible to store the program, which is used in the above-described exemplary embodiment, in an external server, such as a cloud server, and to use the program through a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory that, in a case where a reception unit receives an instruction among a plurality of reception units which respectively receive instructions relevant to generation or editing of a product in a recording mode, stores the product and the reception unit in association with each other; and
a display controller that, in a case where the product is selected in a learning mode, performs control such that the reception unit, which is stored in the memory in association with the selected product, is displayed in a predetermined area.

2. The information processing apparatus according to claim 1,
wherein the display controller performs control such that the reception unit is displayed in the predetermined area in time series.

3. The information processing apparatus according to claim 1,
wherein, in a case where the reception unit which is displayed in the predetermined area in the learning mode is selected, the display controller performs control such that usage explanation of a function corresponding to the instruction, which is received by the reception unit, is displayed.

4. The information processing apparatus according to claim 2,
wherein, in a case where the reception unit which is displayed in the predetermined area in the learning mode is selected, the display controller performs control such that usage explanation of a function corresponding to the instruction, which is received by the reception unit, is displayed.

5. The information processing apparatus according to claim 3,
wherein the display controller performs control such that the reception unit, which displays the usage explanation of the function, is displayed as a function for recommendation of the reception unit in an area which is different from the predetermined area or is displayed in a different form from other reception units.

6. The information processing apparatus according to claim 4,
wherein the display controller performs control such that the reception unit, which displays the usage explanation of the function, is displayed as a function for recommendation of the reception unit in an area which is different from the predetermined area or is displayed in a different form from other reception units.

7. The information processing apparatus according to claim 5,
wherein, in a case where the reception unit which is displayed as the function of recommendation is instructed a number of times which is equal to or larger than a threshold, the display controller performs control such that the display as the function of recommendation stops.

8. The information processing apparatus according to claim 6,
wherein, in a case where the reception unit which is displayed as the function of recommendation is instructed a number of times which is equal to or larger than a threshold, the display controller performs control such that the display as the function of recommendation stops.

9. The information processing apparatus according to claim 5,
wherein the display controller performs control such that the reception unit which is displayed as the function of recommendation is excluded from the predetermined area.

10. The information processing apparatus according to claim 6,
wherein the display controller performs control such that the reception unit which is displayed as the function of recommendation is excluded from the predetermined area.

11. The information processing apparatus according to claim 1,
wherein, in a case where the reception unit which is displayed in the predetermined area is designated a number of times which is equal to or larger than the threshold, the display controller performs control such that the reception unit is excluded from the predetermined area.

12. The information processing apparatus according to claim 2,
wherein, in a case where the reception unit which is displayed in the predetermined area is designated a number of times which is equal to or larger than the threshold, the display controller performs control such that the reception unit is excluded from the predetermined area.

13. The information processing apparatus according to claim 3,
wherein, in a case where the reception unit which is displayed in the predetermined area is designated a number of times which is equal to or larger than the threshold, the display controller performs control such that the reception unit is excluded from the predetermined area.

14. The information processing apparatus according to claim 4,
wherein, in a case where the reception unit which is displayed in the predetermined area is designated a number of times which is equal to or larger than the threshold, the display controller performs control such that the reception unit is excluded from the predetermined area.

15. The information processing apparatus according to claim 5,
wherein, in a case where the reception unit which is displayed in the predetermined area is designated a number of times which is equal to or larger than the threshold, the display controller performs control such that the reception unit is excluded from the predetermined area.

16. The information processing apparatus according to claim 6,
wherein, in a case where the reception unit which is displayed in the predetermined area is designated a number of times which is equal to or larger than the threshold, the display controller performs control such that the reception unit is excluded from the predetermined area.

17. The information processing apparatus according to claim 7,
wherein, in a case where the reception unit which is displayed in the predetermined area is designated a number of times which is equal to or larger than the threshold, the display controller performs control such that the reception unit is excluded from the predetermined area.

18. The information processing apparatus according to claim 1,
wherein, in a case where a component of the product is selected among the reception units which are displayed in the predetermined area, the display controller performs control such that the reception unit, which has received the instruction in a case where the component is generated or edited, is highlighted to be displayed.

19. The information processing apparatus according to claim 1, further comprising:
a switching unit that switches between the recording mode and the learning mode.

20. A non-transitory computer readable medium storing a program causing a computer which includes a memory to function as:
a memory controller that, in a case where a reception unit receives an instruction among a plurality of reception units which respectively receive instructions relevant to generation or editing of a product in a recording mode, performs control such that the memory stores the product and the reception unit in association with each other; and
a display controller that, in a case where the product is selected in a learning mode, performs control such that the reception unit, which is stored in the memory in association with the selected product, is displayed in a predetermined area.
